(19) United States
(12) Patent Application Publication
(10) Pub. No.: US 2004/0068460 A1
(43) Pub. Date: Apr. 8, 2004

(54) Method and system for achieving an ordinal position in a list of search results returned by a bid-for-position search engine

(76) Inventors: Michael A. Feeley, Amherst, NY (US); Douglas R. Rein, Buffalo, NY (US)

Correspondence Address: George L. Snyder, Jr., Hodgson Russ LLP, Suite 2000, One M&T Plaza, Buffalo, NY, 14203-2391, US

(21) Appl. No.: 10/263,029

(22) Filed: Oct. 2, 2002

(51) Int. Cl. G06F 17/60

(52) U.S. Cl. 705/37

(57) ABSTRACT

A method and system enabling advertisers to achieve a desired ordinal position of a web page link in a list of search results generated by a bid-for-position search engine on the Internet in response to a keyword search is disclosed. The method involves surveying other bid-for-position search engines to collect available bid data, determining a network high bid amount for a keyword of interest and the desired position, and adjusting the advertiser's bid on the keyword to be at least as much as the network high bid amount for that keyword and desired position.

### FIELD OF THE INVENTION

The present invention relates generally to Internet search engines, and more particularly to “bid-for position” search engines.

### BACKGROUND OF THE INVENTION

The transfer of information over computer networks has become an increasingly important means by which institutions, corporations, and individuals do business. Computer networks have grown over the years from independent and isolated entities established to serve the needs of a single group into vast internets which interconnect disparate physical networks and allow them to function as a coordinated system. Currently, the largest computer network in existence is the Internet. The Internet is a worldwide interconnection of computer networks that communicate using a common protocol. Millions of computers, from low end personal computers to high end super computers, are connected to the Internet.

The Internet has emerged as a large community of electronically connected users located around the world who readily and regularly exchange information. The Internet continues to serve its original purposes of providing access to and exchange of information among government agencies, laboratories, and universities for research and education. In addition, the Internet has rapidly become a global electronic marketplace of goods and services. This transformation of the Internet into a global marketplace was driven in large part by the introduction of an information system known as the World Wide Web (“the web”). The web is a unique distributed database designed to give wide access to a large universe of documents. The database records of the web are in the form of documents known as “pages”. These pages reside on web servers and are accessible via the Internet. The web is therefore a vast database of information dispersed across countless individual computer systems that is constantly changing and has no recognizable organization. Computers connected to the Internet may access the web pages via a program known as a browser, which typically has a graphical user interface. One powerful technique supported by web browsers is known as hyperlinking, which permits web page authors to create links to other web pages which users can then retrieve by using simple point-and-click commands on the web browser.

Web pages may be constructed in any one of a variety of formatting conventions, such as Hyper Text Markup Language (HTML), and may include multimedia information content such as graphics, audio, and moving pictures. Any person with a computer and a connection to the Internet may access any publicly accessible page posted on the web. Thus, a presence on the World Wide Web has the capability to introduce a worldwide base of consumers to businesses, individuals, and institutions seeking to advertise their products and services to potential customers. Furthermore, the ever increasing sophistication in the design of web pages, made possible by the exponential increase in data transmission rates and computer processing speeds, makes the web an increasingly attractive medium for advertising and other business purposes, as well as for the free flow of information.

The availability of powerful new tools that facilitate the development and distribution of Internet content has led to a proliferation of information, products, and services offered on the Internet and dramatic growth in the number of consumers using the Internet. As a result, directories and search engines have been developed to index and search the information available on the web and thereby help Internet users locate information of interest. These search services enable consumers to search the Internet for a listing of web sites or web pages based on a specific topic, product, or service of interest.

Search services are, after e-mail, the most frequently used tool on the Internet. As a result, web sites providing search services have offered advertisers significant reach into the Internet audience and have given advertisers the opportunity to target consumer interests based on keyword or topical search requests. In a web-based search on an Internet search engine, a user enters a search term comprising one or more keywords, which the search engine then uses to generate a listing of web pages that the user may access via a hyperlink. Many search engines and web site directories of the prior art rely upon processes for assigning results to keywords that often generate irrelevant search results. The automated search technology that drives many search engines in the prior art implements complex database search algorithms that select and rank web pages based on multiple criteria such as keyword density and keyword location. In addition, search engines that use automated search technology to catalog search results generally rely on invisible web site descriptions, or “meta tags”, that are authored by web site promoters. Web site owners may freely tag their sites as they choose. Consequently, some web site promoters insert popular search terms into their web site meta tags that are not relevant to the web site, because by doing so they may attract additional consumer attention at little to no marginal cost. Finally, many different web sites can have similar meta tags, and search engines of the type described above are simply not equipped to prioritize results in accordance with consumers' preferences.

Existing search engines and web site directories may also rely on the manual efforts of limited editorial staffs to review web page information. Because comprehensive manual review and indexing of an unpredictable, randomly updated database such as the web is an impossible task, search engine results are often incomplete or out-of-date. Moreover, as the volume and diversity of Internet content has grown, on many popular web search sites, consumers must frequently click-through multiple branches of a hierarchical directory to locate web sites responsive to their search request, a process that is slow and unwieldy from the consumer's standpoint.

Furthermore, the use of banner advertising for generating web site traffic follows traditional advertising approaches and fails to utilize the unique attributes of the Internet. In the banner advertising model, web site promoters seeking to promote and increase their web exposure often purchase space on the pages of popular commercial web sites. The web site promoters usually fill this space with a colorful graphic, known as a banner, advertising their own web site. The banner may act as a hyperlink to the promoter's site. Like traditional advertising, banner advertising on the Internet is typically priced on an impression basis with advertisers paying for exposures to potential consumers. Banners may be displayed at every page access, or, on search engines, may be targeted to search terms. Nonetheless, impression-based advertising inefficiently exploits the Internet's direct marketing potential, as the click-through rate, the rate of consumer visits a banner generates to the promoter's web site, may be quite low. Web site promoters are therefore paying for exposure to many consumers who are not interested in the product or service being promoted, as most visitors to a web site seek specific information and may not be interested in the information announced in the banner. Likewise, the banner often fails to reach interested individuals, since the banner is not generally searchable by search engines and the interested persons may not know where on the web to view the banner.

One approach that has emerged to help web page owners target their web exposure and distribute information to the attention of interested users on a current and comprehensive basis is the “bid-for-position” search engine (also known as “bid-for-location” and “pay-per-click” search engine). Under this approach, web page owners or promoters maintain an account with the bid-for-position search engine and register respective competitive bid amounts on keywords related to web page or web site content. Search results are returned by the bid-for-position search engine in an order determined by the competitive bids, with the web site of the high bidder for the searched keyword being listed first and so on. Accordingly, under the bid-for-position model, web site promoters can control the placement of their web site link in search result listings so that their link is prominent in searches that are relevant to the content of their web site. Because advertisers and promoters must pay for each click-through referral coming from the search result listing generated by the bid-for-position search engine, they have an incentive to select and bid on those search keywords that are most relevant to their web site offerings and content. The higher an advertiser's position on a search result list, the higher likelihood of a “referral”; that is, the higher the likelihood that a consumer will be referred to the advertiser's web site through the search result list. The openness of this advertising marketplace is further facilitated by publicly displaying, to consumers and other advertisers, the price bid by an advertiser on a particular search result listing.

As bid-for-position search engines have become more popular, it has become commonplace for bid-for-position search engines to partner with each other and share search results and capabilities. Also, it has become more difficult for web site promoters and advertisers to monitor their bidding accounts with various bid-for-position search engines on the Internet to ensure that their web sites are widely listed at a desired position, for example in the top or number one placement position, for a given keyword search. It is known for individual bid-for-position search engines to provide their account holders with bid monitoring and bid management tools for enabling the account holder to maintain a desired ranking or position and eliminate large “bid gaps” between its bid and that of the next highest bidder based only on the accounts of that particular search engine. See, for example, http://www.positionguardian.com. What is needed, however, is a method and system for achieving a desired position on a network-wide basis across a plurality of bid-for-position search engines.

### SUMMARY OF THE INVENTION

Therefore, it is an object of the present invention to provide a method and system for surveying keyword bids across a network of bid-for-position search engines and adjusting an account owner's bids based on data obtained by the survey to help the account owner achieve a desired ordinal position for a web site listing on a plurality of bid-for-position search engines.

It is another object of the present invention to provide a method and system that surveys keyword bids automatically on a network-wide basis at scheduled times and adjusts an account owner's bids according to the account owner's desired ranking or position for a web site listing.

It is also an object of the present invention to provide a method and system that surveys keyword bids on a network-wide basis and determines proposed new bid amounts in response to an inputted command, which new bid amounts can be confirmed and registered in response to another inputted command.

In furtherance of these and other objects, a method according to the present invention generally comprises the steps of surveying a plurality of different bid-for-position search engines to collect bid data; determining a network high bid amount with respect to a keyword across the plurality of different bid-for-position search engines based on the collected bid data, with the network high bid amount corresponding to a desired ordinal position or rank; and adjusting the competitive bid amount of an advertiser to be at least as much as the network high bid amount for that keyword. The step of surveying the different bid-for-position search engines is preferably performed automatically by “spider” software programs crawling through Internet for the purpose of retrieving bid data from partner and competitor bid-for-position search engines, but may also be performed manually by individuals visiting the search engine web sites to collect available bid data, or by a combination of automatic and manual techniques. Under a presently preferred scheme, actual bid data is collected for a set of most frequently searched keywords to enable an actual network high bid amount to be determined for those keywords. For other less-frequently searched keywords, an aggregate adjustment ratio or percentage is computed based on the collected bid data. The aggregate adjustment ratio represents a proportional adjustment that must be made, on average, to keyword bids in a bid account to bring the bids into agreement with a network high bid. Thus, an estimated high bid amount is determined for less-frequently searched keywords. Periodic surveys and bid adjustments in an account can be made automatically if this is agreed to by the account owner. Otherwise, an interface web page may be provided to allow an account owner or search engine administrator to select desired listing positions associated with different keywords and institute a survey to display corresponding network high bid determinations before the adjustments are registered in the account by a separate command.

The present invention also encompasses a computer system for implementing a method as summarized above.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic diagram of a computer network system embodying the present invention;

FIG. 2 is a screen capture showing a partial list of search results generated by a bid-for-position search engine of the present invention;

FIG. 3 shows an example of an account management report for an account of a bid-for-position search engine implementing a method and system according to one embodiment of the present invention;

FIG. 4 shows an example of a user interface for an account of a bid-for-position search engine implementing a method and system according to another embodiment of the present invention; and

FIG. 5 is a flow chart illustrating a method of the present invention.

### DETAILED DESCRIPTION OF THE INVENTION

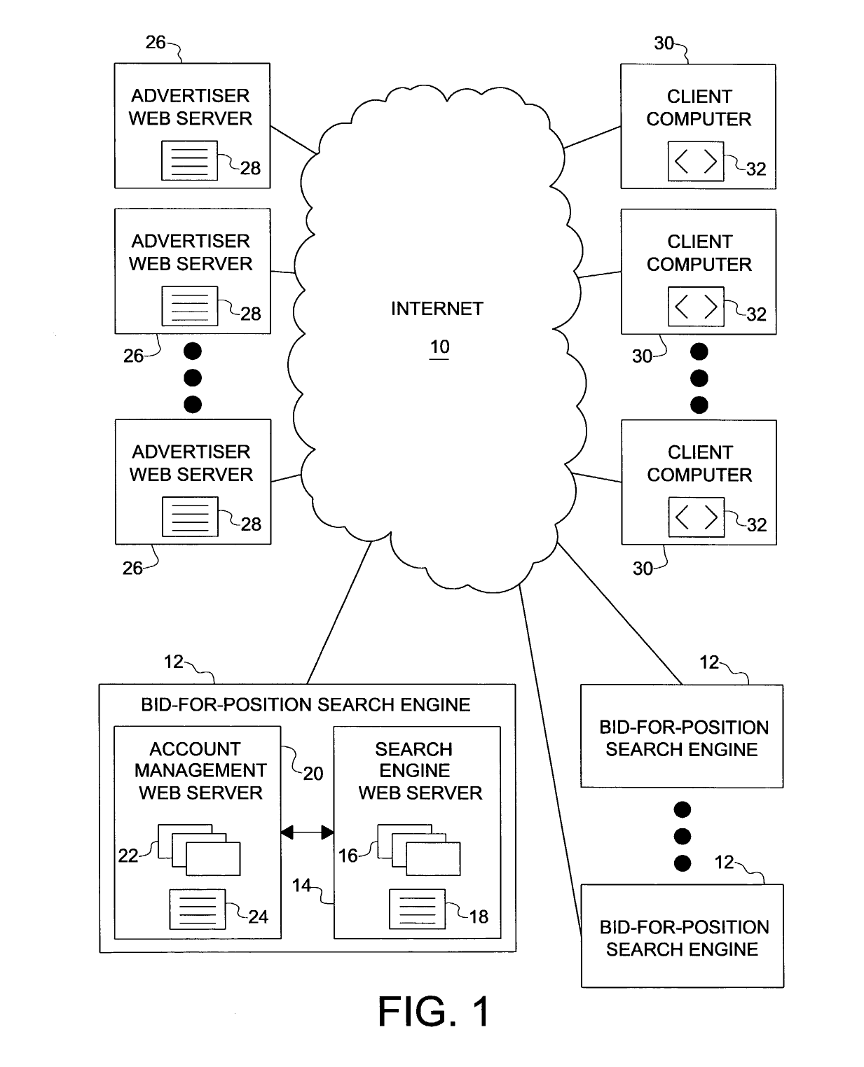

Referring initially to FIG. 1 of the drawings, a computer network system is shown schematically as including a plurality of bid-for-position search engines 12, a plurality of advertiser web servers 26, and a plurality of client computers 30, all of which are interconnected through the Internet 10. A primary bid for position search engine 12 is shown in detail as having a search engine web server 14 and an account management web server 20 connected to the search engine web server to exchange information therewith. Search engine web server 14 stores a search engine database 16 and programming for generating a search engine web page 18 on which search results are displayed. Account management web server 20 stores an accounts database 22 and programming for generating a secure account web page 24. Each advertiser web server 26 stores programming for generating an advertiser web page 28 that promotes or offers goods or services, or provides other information which can be accessed by members of the public using client computers 30 connected to Internet 10 and having executable browser software 32 stored thereon. As will be appreciated, advertisers promoting web pages 28 have accounts with one or more bid-for-position search engines 12, and members of the public using client computers 30 may visit the search engine web page 18 or an affiliate web page to run a keyword search that returns a list of matching links to various web pages 28 from search engine database 16.

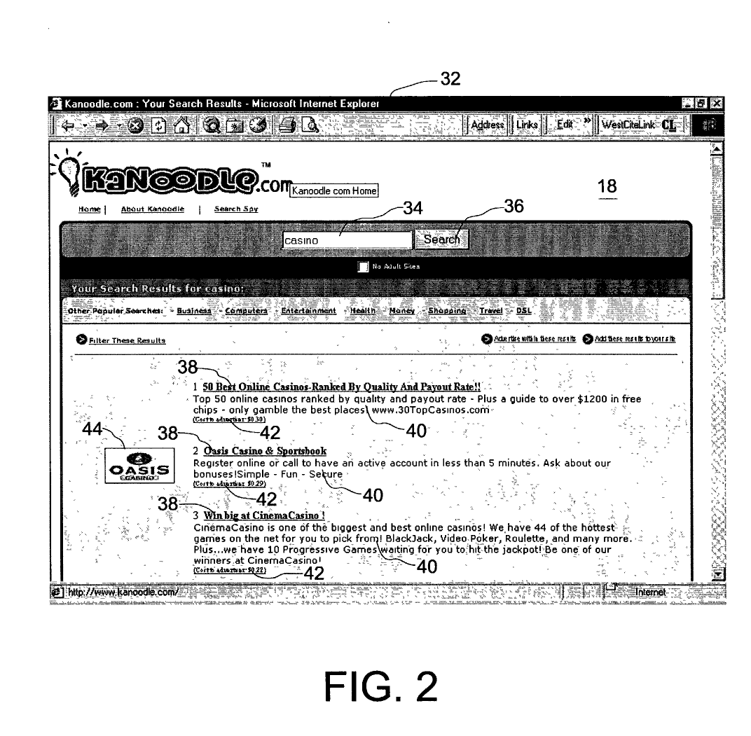

FIG. 2 shows an example of a search engine web page 18 generated by a bid-for-position search engine 12. Search engine web page 18 includes a text box 34 in which a client may enter a search keyword or string of keywords, a “Search” command button. 36 that is clicked to begin execution of a database search for the entered keyword, and a list of ordered search results. Each listing includes a link 38 to an advertiser web page 28, a description 40, and a bid datum 42 indicating the bid amount associated with the listing position. The order in which the links are listed on search engine web page 18 is a function of bid amounts registered by advertisers in account database 22 with respect to the searched keyword. Each time a client “clicks through” to an advertiser's web page 28, the bid amount is charged to the advertiser's account. For example, FIG. 2 shows the top three search result listings for the keyword “casino”. The first position was achieved by a bid of $0.30 per click through, the second position was achieved by a bid of $0.29 per click through, and the third position was achieved by a bid of $0.22. Thus, an advertiser such as a casino desiring to achieve a third position listing with the search engine 12 for this search would have to bid at least $0.22 for this position. FIG. 2 further shows a banner 44 next to the second position listing, which banner may be offered by the search engine to top listings as an incentive for advertisers to register higher bids.

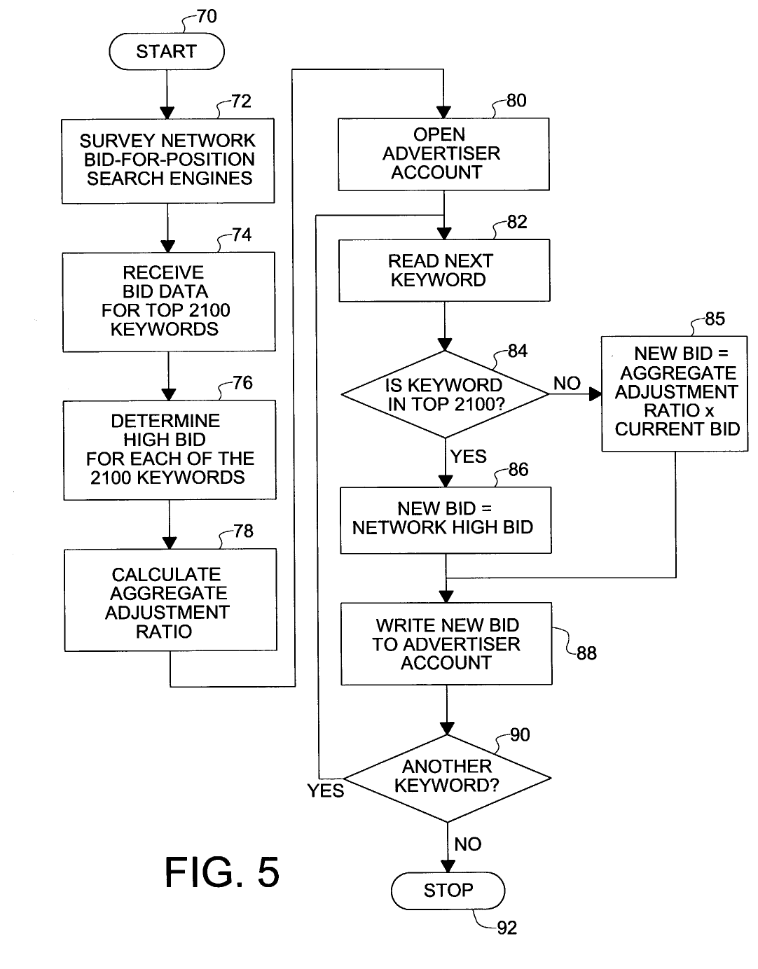

Attention is directed now to FIG. 5 of the drawings, which illustrates a preferred programmed method of the present invention designed to help an advertiser achieve the top or first ordinal position of a link in a list of links 38 returned as ordered search results by bid-for-position search engines 12 in response to a search request for a keyword associated with the link. The method begins at start block 70. First, a survey of network bid-for-position search engines 12 is conducted pursuant to block 72. This is most efficiently done by “spider” software programs written to automatically retrieve bid data from bid-for-position search engines 12 relating to keywords in a predetermined set of the most frequently searched keywords. Under a current embodiment, bid data for the top 2100 most frequently searched keywords are collected by spider programs. It is also possible to collect bid data manually by visiting various bid-for-position web sites, however this technique is less efficient and is better suited to supplement, rather than replace, the spider programs. The spider programs and bid data received therefrom according to block 74 can be stored on search engine web server 14 or account management web server 20. In block 76, the collected bid data are processed to determine an actual network high bid amount for each keyword in the set of most frequently searched keywords. The bid data are also processed to calculate an aggregate adjustment ratio as indicated by block 78. The aggregate adjustment ratio serves as a multiplier that can be applied to adjust current advertiser bid amounts for keywords that are not included in the set of most frequently searched keywords, such that the product of the current bid amount and the aggregate adjustment ratio yields an estimated network high bid amount for such a less common keyword. The aggregate adjustment ratio is preferably calculated by finding the average ratio of actual network high bid amount to current account bid amount for a sample subset of the 2100 most frequently searched keywords. Thus, if the network high bid amounts are, on average, twice as much as the current account bid amounts, then an aggregate adjustment ratio of 2 or 200% is calculated.

To this point, the method of the invention is non-specific to any particular account owner or advertiser. However, if an account owner or advertiser wishes to achieve a top ranking in search results returned by bid-for-position search engines 12 in the network, then the network high bid amounts and aggregate adjustment ratio must be used to adjust the bid amounts for the search keywords in the advertiser's account. Accordingly, the advertiser's account record is opened in block 80 and a keyword is read in block 82. A query is executed in block 84 to determine whether or not the keyword is one of the set of 2100 most frequently searched keywords. If so, a new bid amount for the keyword is assigned in block 86 by setting the new bid amount equal to the actual network high bid amount for that keyword. If not, a new bid amount for the keyword is found by multiplying the current bid amount by the aggregate adjustment ratio as indicated in block 85, which product represents an estimated network high bid amount for the keyword. The new bid amount is then written to the advertiser's account record in block 88 and the program looks for another keyword in the account according to block 90. If another keyword is in the account, then execution loops back to block 82 for bid adjustment with respect to such keyword. If no further keywords are in the account, then the account is closed and execution is stopped in block 92.

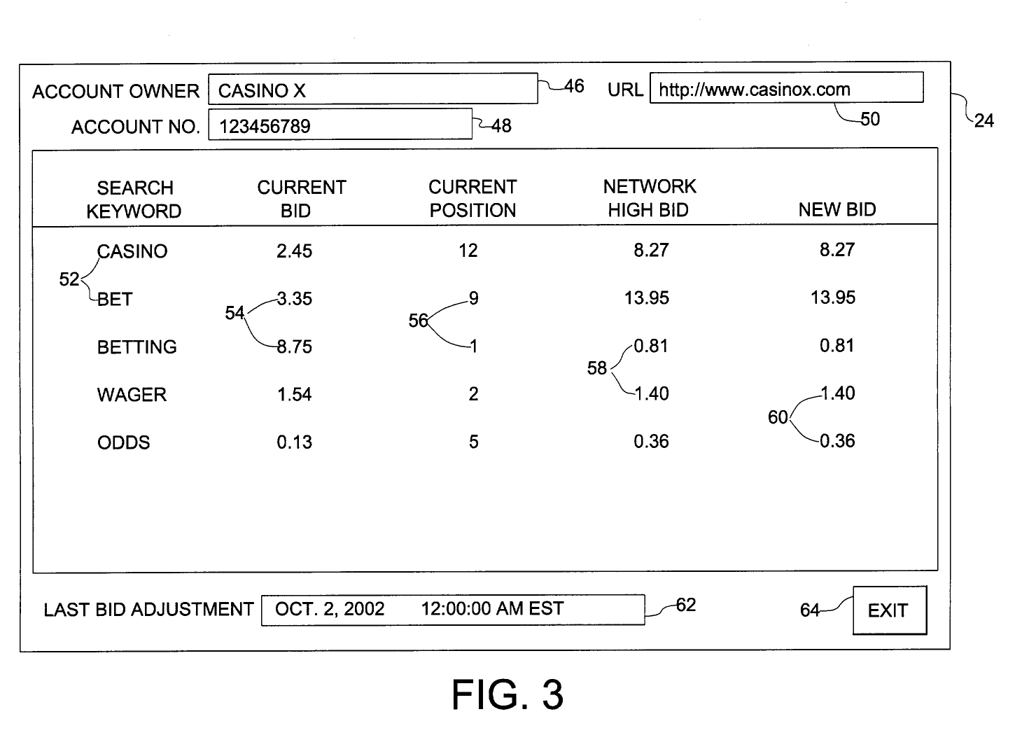

Referring now to FIG. 3, an account management report displayed on account web page 24 illustrates certain account information associated with an account of an advertiser named “CASINO X”. The account owner's name, an account number, and a web page address or Uniform Resource Locator (URL) of the account owner's web page 28 appear in text boxes 46, 48, and 50, respectively. The report contains account bid amount adjustment information resulting from implementation of the method of the present invention described above with reference to FIG. 5. More specifically, a table displays the account keywords 52, current bid amounts 54 before adjustment, current search listing positions 56 before adjustment, network high bid amounts 58, and new bid amounts 60 after adjustment. A date and time text box 62 contains the date and time of the most recent bid adjustment, and an “EXIT” command button 64 is provided.

Because bid amounts for keywords change often on a network-wide basis, it is suggested to execute the method of the present invention automatically at scheduled times. For example, the method could be executed automatically on a regular basis each week to maintain an advertiser's position at or near the top in search results generated by bid-for-position search engines 12. The adjusted bid amounts flow through to other search engines sharing search results on the network.

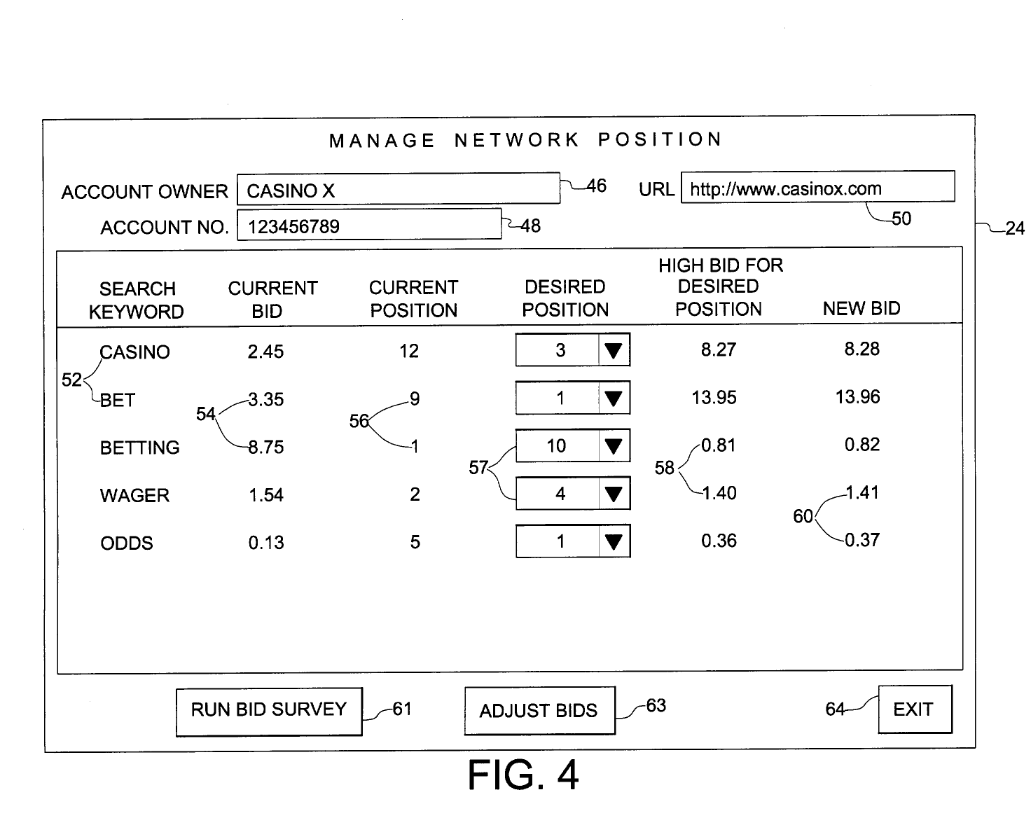

The method described above can be modified in certain respects to give the account owner or an administrator more control over bid amounts and advertising expenditures. FIG. 4 shows an example of a user interface displayed on account web page 24 for managing the network position of keyword search results. The user interface is generally similar to the account management report of FIG. 3, but includes a “Desired Position” drop down menu 57 for each keyword for enabling a user to enter a desired ranking or ordinal position, including positions other than the top or number one position. In this regard, it is important to note that determination of a network high bid amount does not necessarily mean the highest overall bid amount on the network, but rather the highest bid amount resulting in the desired position. Another point of departure in the example of FIG. 4 is that a marginal amount of $0.01 is added to the network high bid amount in calculating the new bid, as can be seen by comparison of the “HIGH BID FOR DESIRED POSITION” and “NEW BID” columns. The user interface further includes a “RUN BID SURVEY” command button 61 and an “ADJUST BIDS” command button 63. When “RUN BID SURVEY” command button 61 is clicked, a network survey is conducted and fresh network high bid amounts 58 are determined and listed. The advertiser can then decide whether to adopt the new bid amounts 60 by clicking “ADJUST BIDS” command button 63, or leave the bid amounts at their current levels by clicking the “EXIT” command button 64. Of course, a greater degree of control could be implemented by providing a separate “ADJUST BID” command button for each individual bid.

As will be appreciated from the foregoing description, the method and system of the present invention provide a convenient way for advertisers to maximize qualified consumer traffic to their web sites, and for search engines to increase their revenue stream. Moreover, these benefits can be realized with existing hardware and and relatively simple programming code that runs in the background to adjust bids on a regular basis.

What is claimed is:

1. A method of achieving a desired ordinal position of a link in a list of links returned as ordered search results by a bid-for-position search engine in response to a search request for a keyword associated with said link, said bid-for-position search engine being one of a plurality of different bid-for-position search engines connected by an information network, said link corresponding to a page promoted by an advertiser having an account with one of said plurality of bid-for-position search engines for registering a competitive bid amount with respect to said keyword, said method comprising the steps of:
surveying said plurality of different bid-for-position search engines to collect bid data;
determining a network high bid amount with respect to said keyword across said plurality of different bid-for-position search engines based on said bid data, said network high bid amount corresponding to said desired ordinal position; and
adjusting said competitive bid amount of said advertiser to be at least as much as said network high bid amount.

2. The method according to claim 1, wherein said step of surveying said plurality of different bid-for-position search engines is performed automatically.

3. The method according to claim 2, wherein said step of surveying said plurality of different bid-for-position search engines is performed by spider software programs.

4. The method according to claim 1, wherein said network high bid amount is an actual high bid amount.

5. The method according to claim 1, wherein said network high bid amount is an estimated high bid amount.

6. The method according to claim 5, wherein said competitive bid amount of said advertiser is adjusted by multiplying said competitive bid amount by an adjustment ratio.

7. The method according to claim 6, wherein said adjustment ratio is calculated using said bid data.

8. The method according to claim 1, wherein said surveying, determining, and adjusting steps are performed repeatedly to maintain said desired ordinal position.

9. The method according to claim 8, wherein said surveying, determining, and adjusting steps are performed automatically at scheduled times.

10. The method according to claim 1, wherein said surveying and determining steps are performed in response to an inputted command.

11. The method according to claim 1, wherein said adjusting step is performed in response to an inputted command.

12. A system for achieving a desired ordinal position of a link in a list of links returned as ordered search results by a bid-for-position search engine in response to a search request for a keyword associated with said link, said bid-for-position search engine being one of a plurality of different bid-for-position search engines connected by an information network, said link corresponding to a page promoted by an advertiser having an account with one of said plurality of bid-for-position search engines for registering a competitive bid amount with respect to said keyword, said system comprising:
a computer system having stored thereon
an account database for recording said keyword and said competitive bid amount of said advertiser;
programming code for surveying said plurality of different bid-for-position search engines and collecting bid data therefrom;
programming code for determining a network high bid amount with respect to said keyword across said plurality of different bid-for-position search engines based on said bid data, said network high bid amount corresponding to said desired ordinal position; and
programming code for adjusting said competitive bid amount of said advertiser to be at least as much as said network high bid amount.

13. The system according to claim 12, wherein said programming code for surveying said plurality of different bid-for-position search engines, said programming code for determining a network high bid amount, and said programming code for adjusting said competitive bid amount is executed at scheduled times.

14. The system according to claim 12, wherein said programming code for surveying said plurality of different bid-for-position search engines and said programming code for determining a network high bid amount is executed in response to an inputted command.

15. The system according to claim 14, wherein said programming code for surveying said plurality of different bid-for-position search engines and said programming code for adjusting said competitive bid amount is executed in response to another inputted command.
